(19) United States
(12) Patent Application Publication
(10) Pub. No.: US 2015/0370007 A1
(43) Pub. Date: Dec. 24, 2015

(54) LIGHT GUIDE WITH INTEGRATED ICON

(71) Applicant: ARRIS Enterprises, Inc., Suwanee, GA (US)

(72) Inventor: J. Stephen Wells, Flowery Branch, GA (US)

(21) Appl. No.: 14/311,847

(22) Filed: Jun. 23, 2014

(51) Int. Cl. F21V 8/00; B29D 11/00; B29C 45/76

(52) U.S. Cl. CPC G02B 6/0096; B29C 45/76; B29D 11/00663; B29L 2011/0075

(57) ABSTRACT

A method of manufacture can produce an apparatus for reflecting light from a light source to an icon, wherein the icon is integrated with the apparatus. An extrusion in the shape of the icon can be molded onto one end of the apparatus. In embodiments, the extrusion can extend into a panel cut-out, wherein the panel cut-out is the same shape as the extrusion.

### TECHNICAL FIELD

This disclosure relates to a light guide.

### BACKGROUND

In electronic devices, status indicators are typically illuminated by light from a light-emitting diode (LED). Generally, LED status indicators use a light guide to carry light from the LED to a location on an outer panel. In order to create an icon or symbol that is illuminated by the light from the LED, typically, pad printing or laser etching is applied to a flat end of a light guide in order to allow the light to pass through the outer end of the light guide in the shape of the specific icon or symbol.

### BRIEF DESCRIPTION OF THE DRAWINGS

FIG. 1 is a perspective view of a device surface with status indicator cut-outs and an example orientation of multiple light guides that are operable to carry light from a light source to a status indicator cut-out.

FIG. 2 is an illustration of multiple light guides with various examples of status indicator extrusions molded onto one end of each light guide.

FIG. 3 is an illustration showing dimensions of an example status indicator extrusion molded onto one end of a light guide.

Like reference numbers and designations in the various drawings indicate like elements.

### DETAILED DESCRIPTION

In embodiments, an apparatus is operable to illuminate an icon without the use of techniques (e.g., pad printing, laser etching, etc.) for manipulating a surface that is to be illuminated. In embodiments, a light guide may include an extrusion in the shape of an icon molded on one end of the light guide.

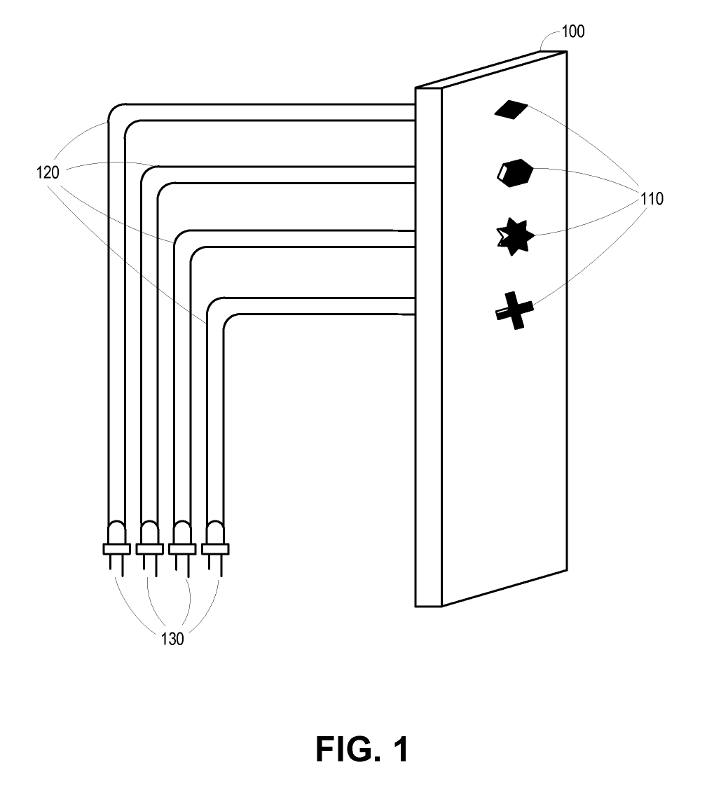

FIG. 1 is a perspective view of a device surface 100 with status indicator cut-outs 110 and an example orientation of multiple light guides 120 that are operable to carry light from a light source to a status indicator cut-out. In embodiments, a light guide 120 can reflect light from a light source (e.g., LED 130) to a location on a device surface 100 (e.g., icon opening 110). In embodiments, a light guide 120 may include one or more angles that are operable to reflect light from a light source around bends in the light guide. In embodiments, a light guide 120 can be made from various translucent materials (e.g., polycarbonate, acrylic, epoxy, glass, etc.). It should be understood that a light guide 120 can be made of any material that is operable to transmit light.

In embodiments, a device surface 100 (e.g., the exterior surface of an electronic device) may include one or more status indicator cut-outs 110. For example, indicator cut-outs 110 can be of the same shapes and dimensions as the shapes and dimensions of various status indicators, and each indicator cut-out 110 can extend all the way through the device surface 100. In embodiments, each of the multiple light guides 120 can extend from a LED 130 to a specific indicator cut-out 110. It should be understood that a single LED can provide light for multiple light guides 120.

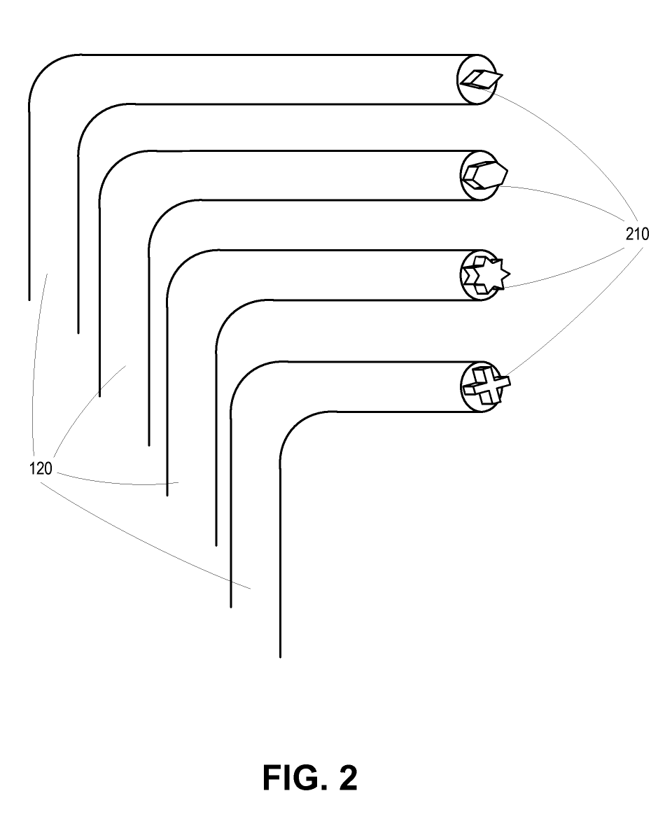

FIG. 2 is an illustration of multiple light guides 120 with various examples of status indicator extrusions 210 molded onto one end of each light guide. In embodiments, each status indicator extrusion 210 can be of the same shape as a status indicator cut-out 110 of FIG. 1. In embodiments, each status indicator extrusion 210 can be so dimensioned as to fit within and extend partially or wholly through an opening created by an associated status indicator cut-out 110. It should be understood that the shapes shown in FIG. 2 are examples, and that the status indicator extrusions 210 can be of various shapes and sizes.

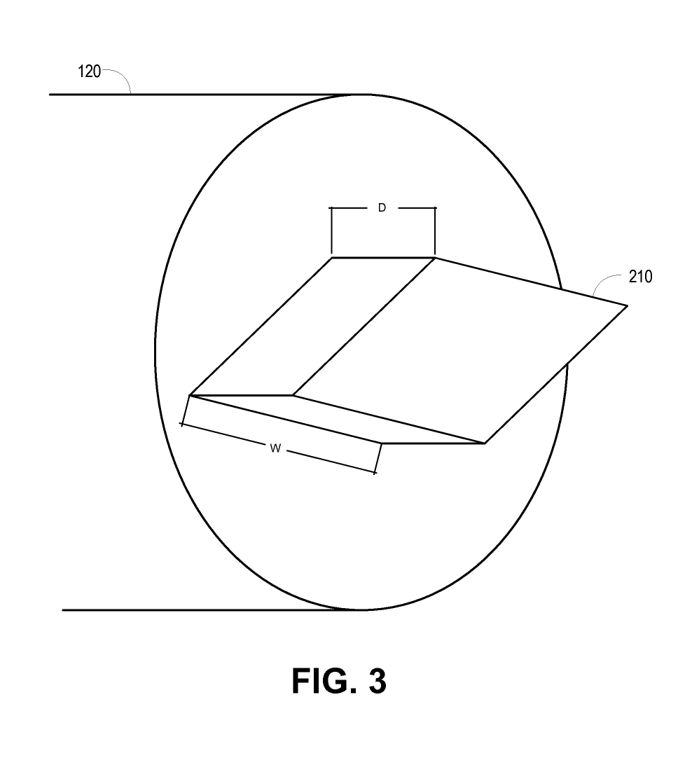

FIG. 3 is an illustration showing dimensions of an example status indicator extrusion 210 molded onto one end of a light guide 120. The depth of a status indicator extrusion 210 is represented by the dimension “D.” The width of an edge of a status indicator 210 is represented by the dimension “W.” In embodiments, the width “W” of each edge of a status indicator extrusion 210 can be less than the width of an associated edge of a status indicator cut-out 110 of FIG. 1. In embodiments, the depth of a status indicator extrusion 210 can be so dimensioned as to cause the status indicator extrusion to extend partially or wholly through an associated status indicator cut-out 110.

In embodiments, a light guide 120 and an associated status indicator extrusion 210 can be a single component. For example, a light guide 120 and an associated status indicator extrusion 210 can be injection molded as a single component. In embodiments, a minimum width to depth ratio (e.g., the ratio of the width of a status indicator extrusion's smallest edge over the depth of the status indicator extrusion) can be determined for a status indicator extrusion 210. The minimum width to depth ratio can be large enough such that the status indicator extrusion 210 is not damaged during the injection molding process. For example, the geometry of portions of a status indicator extrusion 210 can be tapered in order to maintain a width to depth ratio above the minimum width to depth ratio. In embodiments, a minimum width to depth ratio can be based upon the type of material the light guide 120 is made of. In embodiments, a status indicator extrusion 210 can be dimensioned so that each edge of the status indicator extrusion has a width to depth ratio that is greater than the minimum width to depth ratio associated with the material from which the status indicator extrusion is made.

We claim:

1. An apparatus comprising:
a panel having a cut-out;
a light guide having an extrusion at one end, wherein the extrusion is in the same shape as the cut-out; and
a light source at another end of the light guide.

2. The apparatus of claim 1, wherein the cut-out is in the shape of a status indicator.

3. The apparatus of claim 1, wherein the light source is a light-emitting diode.

4. The apparatus of claim 1, wherein the lengths of the edges of the extrusion are less than the corresponding edges of the cut-out.

5. The apparatus of claim 4, wherein the extrusion extends into the cut-out.

6. The apparatus of claim 1, wherein the light guide comprises a translucent material.

7. A method of molding a light guide comprising the steps of:
injecting a molten material into a cavity, wherein the cavity comprises a body portion for forming a body of the light guide and an extrusion portion for forming an extrusion on one end of the body of the light guide.

8. The method of claim 7, wherein the extrusion is in the same shape as a cut-out on a panel.

9. The method of claim 8, wherein the cut-out is in the shape of a status indicator.

10. The method of claim 8, wherein the lengths of the edges of the extrusion are less than the corresponding edges of the cut-out.

11. The method of claim 8, wherein the depth of the extrusion is so dimensioned as to allow the extrusion to extend into the cut-out.

12. The method of claim 7, further comprising:
determining a minimum edge to depth ratio based upon the material injected into the cavity.

13. The method of claim 12, wherein the depth of the extrusion and the smallest edge of the extrusion are dimensioned so that the ratio of the length of the smallest edge over the depth is greater than a minimum edge to depth ratio.

14. An apparatus for reflecting light comprising:
a first end for accepting light from a light source;
a body comprising a translucent material;
a second end that is flat; and
an extrusion extending from the second end.

15. The apparatus of claim 14, wherein the extrusion is the same shape as a cut-out on a panel.

16. The apparatus of claim 15, wherein the cut-out is in the shape of a status indicator.

17. The apparatus of claim 15, wherein the lengths of the edges of the extrusion are less than the corresponding edges of the cut-out.

18. The apparatus of claim 15, wherein the extrusion extends into the cut-out.

19. The apparatus of claim 14, wherein the light source is a light-emitting diode.

20. The apparatus of claim 14, wherein the light guide comprises a translucent material.
